(19) United States
(12) Patent Application Publication
(10) Pub. No.: US 2024/0248258 A1
(43) Pub. Date: Jul. 25, 2024

(54) OPTICAL COUPLER FOR VERTICAL OPTICAL COUPLING

(71) Applicant: Cisco Technology, Inc., San Jose, CA (US)

(72) Inventors: Norbert SCHLEPPLE, Macungie, PA (US); Donald J. ADAMS, San Jose, CA (US); Vipulkumar K. PATEL, Breinigsville, PA (US)

(21) Appl. No.: 18/157,626

(22) Filed: Jan. 20, 2023

(51) Int. Cl. G02B 6/30

(52) U.S. Cl. CPC G02B 6/305

(57) ABSTRACT

An optical coupler and a method performed by the optical coupler are described. The optical coupler includes an interlayer dielectric, a waveguide disposed within the interlayer dielectric, and an epoxy disposed on the interlayer dielectric and in the first cavity such that the epoxy defines an upper surface and a bottom surface. The interlayer dielectric includes a first surface and a second surface coupled to the first surface. The first surface and the second surface define a first cavity in the interlayer dielectric. The waveguide emits an optical signal through the first surface. The bottom surface is positioned between the interlayer dielectric and the upper surface. The epoxy directs the optical signal from the first surface to the second surface. The second surface and the epoxy direct a first portion of the optical signal through the upper surface.

### TECHNICAL FIELD

Embodiments presented in this disclosure generally relate to optical communications. More specifically, embodiments disclosed herein to an optical coupler.

### BACKGROUND

Optical couplers direct optical signals between devices. For example, an optical coupler may direct an optical signal from a waveguide or fiber to another fiber, integrated circuit, or photodetector.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example configuration of the system of FIG. 1.

FIG. 3 illustrates an example configuration of the system of FIG. 1.

FIG. 4 illustrates an example configuration of the system of FIG. 1.

FIG. 5 illustrates an example configuration of the system of FIG. 1.

FIG. 6 illustrates an example system.

FIG. 7 is a flowchart of an example method performed in the systems of FIGS. 1 and 6.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

According to an embodiment, an optical coupler includes an interlayer dielectric, a waveguide disposed within the interlayer dielectric, and an epoxy disposed on the interlayer dielectric and in the first cavity such that the epoxy defines an upper surface and a bottom surface. The interlayer dielectric includes a first surface and a second surface coupled to the first surface. The first surface and the second surface define a first cavity in the interlayer dielectric. The waveguide emits an optical signal through the first surface. The bottom surface is positioned between the interlayer dielectric and the upper surface. The epoxy directs the optical signal from the first surface to the second surface. The second surface and the epoxy direct a first portion of the optical signal through the upper surface.

According to another embodiment, a method includes emitting, by a waveguide disposed within an interlayer dielectric comprising a first surface and a second surface coupled to the first surface, an optical signal through the first surface. The first surface and the second surface define a first cavity in the interlayer dielectric. The method also includes directing, by an epoxy disposed on the interlayer dielectric and in the first cavity such that the epoxy defines an upper surface and a bottom surface, the optical signal from the first surface to the second surface. The bottom surface is positioned between the interlayer dielectric and the upper surface. The method further includes directing, by the second surface and the epoxy, a first portion of the optical signal through the upper surface.

According to another embodiment, an optical coupler includes an interlayer dielectric and an epoxy. The interlayer dielectric includes a first surface and a second surface that define a cavity in the interlayer dielectric. The epoxy is disposed on the interlayer dielectric and in the cavity. The epoxy includes an upper surface and a bottom surface positioned between the interlayer dielectric and the upper surface. The epoxy directs an optical signal from the first surface to the second surface. The second surface and the epoxy direct the optical signal through the upper surface.

### Example Embodiments

Optical couplers direct optical signals between devices (e.g., from a waveguide or fiber to another fiber, integrated circuit, or photodetector). The aspect ratios of optical devices (e.g., photonic integrated circuits) have been increasing such that the optical devices have thinner dies and larger footprints, which results in physical warpage of the device surfaces. These warpages may result in optical coupling penalties. In some instances, grating couplers may be used to provide vertical optical coupling, which avoids the coupling penalties resulting from the physical warpages. Grating couplers, however, target a narrow band of optical wavelengths and may be polarization sensitive.

The present disclosure describes an optical coupler that provides vertical optical coupling. The optical coupler includes an interlayer dielectric that defines a cavity. The cavity is filled with an epoxy, which may be index matched with the interlayer dielectric or may have a higher index of refraction than the interlayer dielectric. The epoxy directs an optical signal traveling laterally in the cavity towards a surface of the cavity that redirects the optical signal upwards into a fiber or another optical device. In this manner, the optical coupler provides for vertical optical coupling with a wide spectral bandwidth, in certain embodiments.

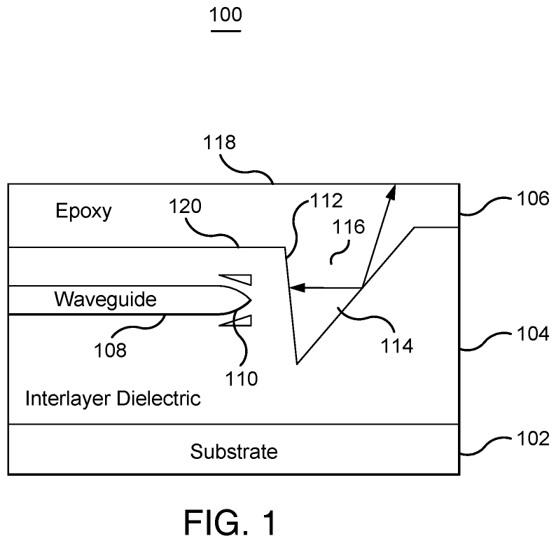

FIG. 1 illustrates an example system 100. Generally, the system 100 may be an optical coupler. As seen in FIG. 1, the system 100 includes a substrate 102, an interlayer dielectric 104, and an epoxy 106. In certain embodiments, the system 100 provides vertical optical coupling by redirecting an optical signal traveling laterally through the system 100 upwards out of the system 100.

The substrate 102 forms the base of the system 100 and may provide foundational or structural support for the other components or layers of the system 100 (e.g., the interlayer dielectric 104 and the epoxy 106). The substrate 102 may include a semiconductor material, such as silicon. In certain embodiments, the other components or layers of the system 100 may be formed or disposed on the substrate 102 to form the system 100.

The interlayer dielectric 104 may be disposed on or formed on the substrate 102. The interlayer dielectric 104 may be any suitable material that allows for the transmission of optical signals. For example, the interlayer dielectric 104 may be a material through which an optical signal may travel. As seen in FIG. 1, a waveguide 108 is positioned within the interlayer dielectric 104. An optical signal may travel through the waveguide 108 and into the interlayer dielectric 104. The waveguide 108 may include a spot size converter 110 at the end of the waveguide 108. The spot size converter 110 may reduce a mode field of an optical signal traveling through the waveguide 108 before the optical signal is emitted from the waveguide 108 into the interlayer dielectric 104.

The interlayer dielectric 104 includes a surface 112 and a surface 114. The surface 112 and the surface 114 may be angled with respect to each other. Additionally, the surface 112 and the surface 114 may intersect to form a cavity 116 in the interlayer dielectric 104. As seen in FIG. 1, the cavity 116 may be triangular in shape. An optical signal emitted by the waveguide 108 may travel through the interlayer dielectric 104 and into the cavity 116. In some embodiments, grayscale lithography is used to etch the surface 112, the surface 114, and the cavity 116 into the interlayer dielectric 104. In some instances, wafer level glass molding or embossing may be used to form the surface 112, the surface 114, and the cavity 116.

The epoxy 106 may be disposed on the interlayer dielectric 104. The epoxy 106 may fill the cavity 116 defined by the interlayer dielectric 104. As seen in FIG. 1, the epoxy 106 includes an upper surface 118 and a bottom surface 120. The bottom surface 120 of the epoxy 106 may contact or couple to the interlayer dielectric 104. The upper surface 118 may form a top surface of the system 100. The bottom surface 120 is positioned between the interlayer dielectric 104 and the upper surface 118. In some embodiments, the surface 112 is substantially perpendicular to the bottom surface 120 of the epoxy 106. In certain embodiments, the surface 112 forms a slightly obtuse angle with the bottom surface 120 of the epoxy 106.

In certain embodiments, the interlayer dielectric 104 and the epoxy 106 may have matched refractive indexes. In some embodiments, the epoxy 106 has a higher index of refraction than the interlayer dielectric 104. The indexes of refraction of the interlayer dielectric 104 and the epoxy 106 may be set such that the interlayer dielectric 104 and the epoxy 106 redirect an optical signal upwards through the upper surface 118 of the epoxy 106.

As seen in FIG. 1, an optical signal emitted by the waveguide 108 may travel through the interlayer dielectric 104 into the cavity 116. The index of refraction of the interlayer dielectric 104, the angle of the surface 112, and the index of refraction of the epoxy 106 may allow most or all of the optical signal emitted by the waveguide 108 to travel into the cavity 116. Stated differently, the indexes of refraction of the interlayer dielectric 104 and the epoxy 106, and the angle of the surface 112 may reduce or minimize reflections at the surface 112. The optical signal may travel through the epoxy 106 in the cavity 116 to the surface 114. The indexes of refraction of the interlayer dielectric 104 and the epoxy 106, and the angle of the surface 114 may redirect the optical signal upwards. Stated differently, the indexes of refraction of the interlayer dielectric 104 and the epoxy 106, and the angle of the surface 114 may create a total internal reflection condition that results in the optical signal reflecting towards the upper surface 118 of the epoxy 106. The optical signal may then exit the upper surface 118 to couple to another device. For example, an optical fiber, a photodetector, or another integrated circuit may be positioned on or near the upper surface 118 of the epoxy 106. The optical signal may optically couple into the optical fiber, photodetector, or integrated circuit after exiting through the upper surface 118 of the epoxy 106.

In some instances, an optical signal emitted by the optical device optically coupled to the system 100 through the upper surface 118. The optical signal enters the epoxy 106 through the upper surface 118 and travels towards the surface 114. The indexes of refraction of the interlayer dielectric 104 and the epoxy 106, and the angle of the surface 114 cause the optical signal to be reflected at the surface 114. The optical signal then travels towards the surface 112. The indexes of refraction of the interlayer dielectric 104 and the epoxy 106, and the angle of the surface 112 allow the optical signal to pass through the surface 112 and into the waveguide 108. In this manner, the system 100 provides vertical optical coupling.

Notably, the system 100 provides free-space out-of-plane deflection of horizontal waveguide light into a vertical fiber or component. As a result, the light is not edge coupled into the fiber or component, which eliminates some of the drawbacks of surface warpage. Moreover, the system 100 may provide the optical coupling without using a grating coupler, which may increase the spectral bandwidth of the system 100 relative to systems that use grating couplers.

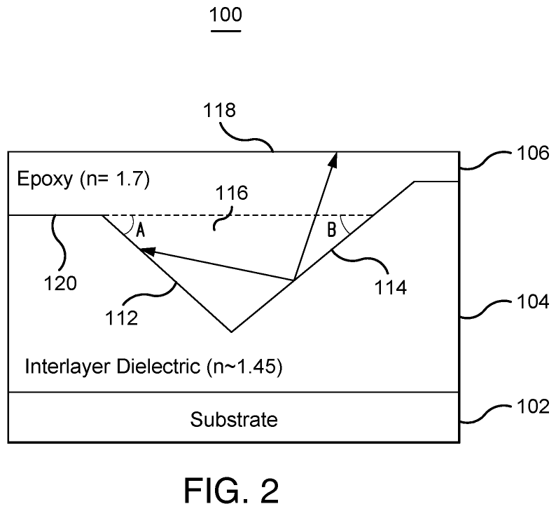

FIG. 2 illustrates an example configuration of the system 100 of FIG. 1. As seen in FIG. 2, the interlayer dielectric 104 and the epoxy 106 are disposed on or formed on the substrate 102. Additionally, the interlayer dielectric 104 includes the surfaces 112 and 114 that intersect to form the cavity 116. The epoxy 106 fills the cavity 116. In the configuration of FIG. 2, the interlayer dielectric has an index of refraction of approximately 1.45, and the epoxy has an index of refraction of 1.7. Thus, the epoxy has a higher index of refraction than the interlayer dielectric.

Additionally, as seen in FIG. 2, the surfaces 112 and 114 are angled with respect to the bottom surface 120 of the epoxy 106. For example, the surface 112 forms an angle A with the bottom surface 120, and the surface 114 forms an angle B with the bottom surface 120. The angle A and the angle B may not be equal to each other. For example, the angle A may be a 60-degree angle, while the angle B may be a 35-degree angle. In some embodiments, the angle A may be substantially 90-degrees.

The indexes of refraction of the interlayer dielectric 104 and the epoxy 106, and the angles of the surfaces 112 and 114 may redirect an optical signal through the cavity 116 and upwards out of the upper surface 118 of the epoxy 106. For example, an optical signal may be traveling laterally through the interlayer dielectric 104 towards the surface 112. The indexes of refraction of the interlayer dielectric 104 and the epoxy 106, and the angle of the surface 112 may redirect the optical signal as the optical signal enters the cavity 116. The optical signal may travel through the cavity 116 towards the surface 114. In the configuration of FIG. 2, there may be some reflection of the optical signal at the surface 112 so that not all of the optical signal travels through the surface 112 and into the cavity 116. The indexes of refraction of the interlayer dielectric 104 and the epoxy 106, and the angle of the surface 114 may redirect the optical signal at the surface 114 towards the upper surface 118 of the epoxy 106. For example, the indexes of refraction of the interlayer dielectric 104 and the epoxy 106, and the angle of the surface 114 may create a total internal reflection condition such that the optical signal at the surface 114 is reflected towards the upper surface 118.

Additionally, an optical signal entering the epoxy 106 through the upper surface 118 may travel through the epoxy 106 and towards the surface 114. The indexes of refraction of the epoxy 106 and the interlayer dielectric 104, and the angle of the surface 114 may cause the optical signal to be reflected at the surface 114. The optical signal may then travel towards the surface 112. The indexes of refraction of the epoxy 106 and the interlayer dielectric 104, and the angle of the surface 112 may cause the optical signal to pass through the surface 112 and travel laterally through the interlayer dielectric 104. In this manner, the system 100 provides vertical optical coupling.

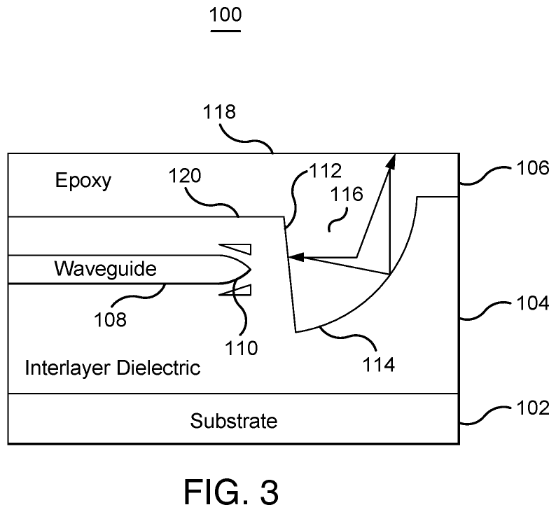

FIG. 3 illustrates an example configuration of the system 100 of FIG. 1. As seen in FIG. 3, the interlayer dielectric 104 and the epoxy 106 are disposed on or formed on the substrate 102. The waveguide 108 with the spot size converter 110 is positioned within the interlayer dielectric 104. Additionally, the interlayer dielectric 104 includes the surfaces 112 and 114 that form the cavity 116 in the interlayer dielectric 104. The epoxy 106 fills the cavity 116.

In the example of FIG. 3, the surface 114 is curved. The non-planar curvature of the surface 114 may shape the beam of the optical signal traveling through the cavity 116. For example, the surface 114 may collimate or focus the beam in the cavity 116. Thus, the curvature of the surface 114 may be adjusted to adjust the free space optical path length of the optical signal.

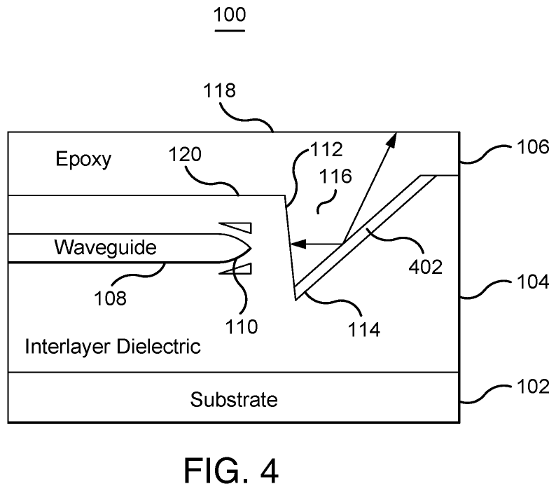

FIG. 4 illustrates an example configuration of the system 100 of FIG. 1. As seen in FIG. 4, the interlayer dielectric 104 and the epoxy 106 are formed or disposed on the substrate 102. The waveguide 108 with the spot size converter 110 is positioned within the interlayer dielectric 104. The interlayer dielectric 104 includes the surfaces 112 and 114 that intersect to form the cavity 116. The epoxy 106 fills the cavity 116.

In the example of FIG. 4, a coating 402 is formed on the surface 114. The coating 402 may be a metal coating that improves the reflectivity of the surface 114. In some embodiments, the coating 402 may be applied using a metal lift or an electroplating process. The optical signal traveling through the cavity 116 may reach the coating 402 and be reflected by the coating 402. In some embodiments, the coating 402 allows for greater freedom on the index of refraction of the epoxy 106. Stated differently, there may be a greater range for the refractive index of the epoxy 106 that still provides for a total internal reflection condition at the surface 114 and the coating 402.

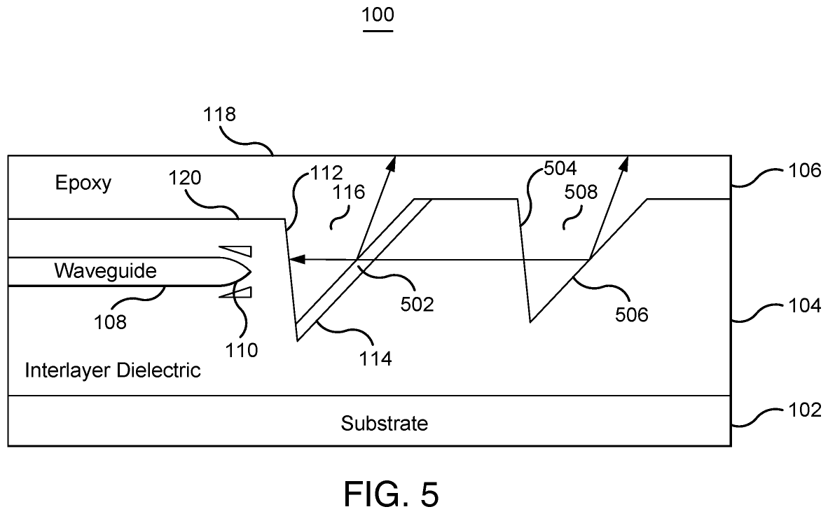

FIG. 5 illustrates an example configuration of the system 100 of FIG. 1. As seen in FIG. 5, the interlayer dielectric 104 and the epoxy 106 are disposed on or formed on the substrate 102. The waveguide 108 with the spot size converter 110 is positioned in the interlayer dielectric 104. The interlayer dielectric 104 includes the surface 112 and the surface 114 that intersect to form the cavity 116. The epoxy 106 fills the cavity 116.

In the example of FIG. 5, a coating 502 is positioned on the surface 114. The coating 502 may be a dielectric coating that is a wavelength selective or polarization selective coating. The coating 502 may include one or multiple layers. The coating 502 provides for selective transmission to separate or combine, for example, different wavelengths or polarizations of an optical signal traveling through the cavity 116. Thus, the coating 502 may reflect portions of the optical signal upwards towards the upper surface 118 and transmit other portions of the optical signal.

As seen in FIG. 5, the interlayer dielectric includes a surface 504 and a surface 506. The surface 504 and the surface 506 may be angled with respect to each other and may intersect to form a cavity 508. The surface 504, the surface 506, and the cavity 508 may be positioned in the path of the optical signal after the surface 112, the surface 114, and the cavity 116. The epoxy 106 may fill the cavity 508. The portions of the optical signal that are transmitted by the coating 502 may travel through the interlayer dielectric 104 towards the surface 504.

The indexes of refraction of the interlayer dielectric 104 and the epoxy 106, and the angle of the surface 504 may allow the portion of the optical signal at the surface 504 to enter the cavity 508. The portion of the optical signal may then travel through the epoxy 106 in the cavity 508 towards the surface 506. The indexes of refraction of the interlayer dielectric 104 and the epoxy 106, and the angle of the surface 506 may reflect the portion of the optical signal at the surface 506 towards the upper surface 118 of the epoxy 106. Multiple optical devices may then couple to the portions of the optical signal exiting the upper surface 118 of the epoxy 106. For example, different fibers of a multicore fiber may optically couple to the portions of the optical signal exiting the upper surface 118. One fiber of the multicore fiber may receive the portion of the optical signal reflected by the coating 502. Another fiber of the multicore fiber may receive the portion of the optical signal reflected by the surface 506.

Additionally, two optical signals may enter the epoxy 106 through the upper surface 118. The first optical signal may travel towards the surface 506 and the second optical signal may travel towards the coating 502 and the surface 114. The indexes of refraction of the interlayer dielectric 104 and the epoxy 106, and the angle of the surface 506 may reflect the first optical signal at the surface 506. The first optical signal may then travel towards the surface 504. The indexes of refraction of the interlayer dielectric 104 and the epoxy 106, and the angle of the surface 504 may cause the first optical signal to pass through the surface 504 and travel towards the coating 502 and the surface 114. The coating 502 may cause the first optical signal to combine with the second optical signal at the coating 502. The indexes of refraction of the interlayer dielectric 104 and the epoxy 106, and the angle of the surface 114 may cause the resulting optical signal to reflect towards the surface 112. The indexes of refraction of the interlayer dielectric 104 and the epoxy 106, and the angle of the surface 112 may cause the resulting optical signal to pass through the surface 112 and travel into the waveguide 108.

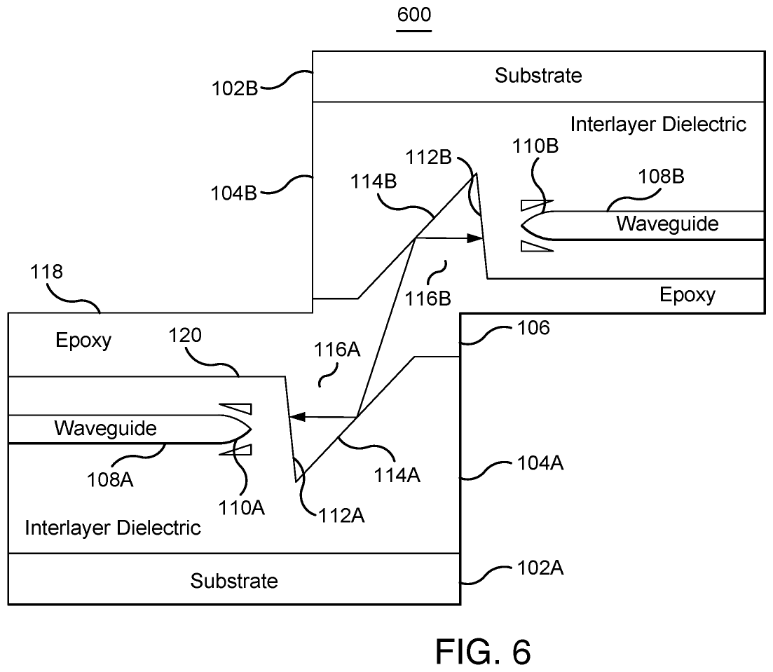

FIG. 6 illustrates an example system 600. Generally, the system 600 provides for vertical optical coupling between two optical couplers. As seen in FIG. 6, the system 600 includes a substrate 102A, an interlayer dielectric 104A, an epoxy 106, a substrate 102B, and an interlayer dielectric 104B. The substrate 102A, the interlayer dielectric 104A, and the epoxy 106 form a first optical coupler. The substrate 102B, the interlayer dielectric 104B, and the epoxy 106 form a second optical coupler. The first optical coupler and the second optical coupler vertically couple optical signals into each other.

The interlayer dielectric 104A and the epoxy 106 are disposed on or formed on the substrate 102A. A waveguide 108A with a spot size converter 110A is positioned in the interlayer dielectric 104A. The interlayer dielectric 104A includes a surface 112A and a surface 114A. The surface 112A and the surface 114A are angled with respect to each other and intersect to form a cavity 116A. The epoxy 106 fills the cavity 116A.

The interlayer dielectric 104B and the epoxy 106 are disposed on or formed on the substrate 102B. The second optical coupler may be flipped onto the first optical coupler. A waveguide 108B with a spot size converter 110B is positioned in the interlayer dielectric 104B. The interlayer dielectric 104B includes a surface 112B and a surface 114B. The surface 112B and the surface 114B are angled with respect to each other, and intersect to form a cavity 116B. The epoxy 106 fills the cavity 116B.

The waveguide 108A may emit an optical signal through the interlayer dielectric 104A towards the surface 112A. The indexes of refraction of the interlayer dielectric 104A and the epoxy 106, and the angle of the surface 112A may allow for transmission of the optical signal into the cavity 116A. The optical signal may then travel towards the surface 114A. The indexes of refraction of the interlayer dielectric 104A and the epoxy 106, and the angle of the surface 114A may reflect the optical signal upwards towards the second optical coupler. The optical signal may travel through the epoxy 106 towards the surface 114B. The indexes of refraction of the interlayer dielectric 104B and the epoxy 106, and the angle of the surface 114B may cause the optical signal to be reflected at the surface 114B. The optical signal may then travel through the cavity 116B towards the surface 112B. The indexes of refraction of the interlayer dielectric 104B and the epoxy 106, and the angle of the surface 112B may allow for transmission of the optical signal. The optical signal may pass through the surface 112B, through the interlayer dielectric 104B, and into the waveguide 108B.

An optical signal emitted by the waveguide 108B may travel through the interlayer dielectric 104B towards the surface 112B. The indexes of refraction of the interlayer dielectric 104B and the epoxy 106, and the angle of the surface 112B may allow transmission of the optical signal. The optical signal may pass through the surface 112B into the cavity 116B. The optical signal may then travel towards the surface 114B. The indexes of refraction of the interlayer dielectric 104B and the epoxy 106, and the angle of the surface 114B may cause the optical signal to be reflected at the surface 114B. The optical signal may then travel through the epoxy 106 towards the surface 114A. The indexes of refraction of the interlayer dielectric 104A and the epoxy 106, and the angle of the surface 114A may cause a reflection of the optical signal at the surface 114A. The optical signal may then travel through the cavity 116A towards the surface 112A. The indexes of refraction of the interlayer dielectric 104A and the epoxy 106, and the angle of the surface 112A may allow transmission of the optical signal through the surface 112A. The optical signal may then travel through the interlayer dielectric 104A to the waveguide 108A. In this manner, the system 600 optically couples the waveguide 108A with the waveguide 108B.

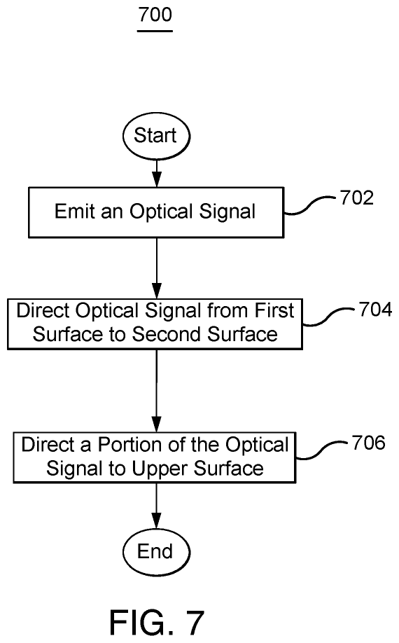

FIG. 7 is a flowchart of an example method 700 performed in the systems 100 and 600 of FIGS. 1 and 6. In particular embodiments, the components of the systems 100 and 600 perform the steps of the method 700. By performing the method 700, the systems 100 and 600 provide vertical optical coupling.

In block 702, a waveguide 108 emits an optical signal. The waveguide 108 may be positioned in an interlayer dielectric 104. The optical signal may travel from the waveguide 108 through the interlayer dielectric 104 towards a first surface 112 of the interlayer dielectric 104.

In block 704, the optical signal is directed from the first surface 112 to a second surface 114 of the interlayer dielectric 104. The indexes of refraction of the interlayer dielectric 104 and an epoxy 106, and the angle of the first surface 112 may allow for transmission of the optical signal. The optical signal may travel through the first surface 112 and towards the second surface 114. The first surface 112 and the second surface 114 may be angled relative to each other and may intersect to form a cavity 116. The optical signal may travel through the cavity 116 towards the second surface 114.

In block 706, a portion of the optical signal is directed to an upper surface 118 of the epoxy 106. The indexes of refraction of the interlayer dielectric 104 and the epoxy 106, and the angle of the second surface 114 may cause a reflection of the optical signal at the second surface 114. For example, the optical signal may be reflected upwards towards the upper surface 118 of the epoxy 106. In some embodiments, the indexes of refraction of the interlayer dielectric 104 and the epoxy 106, and the angle of the second surface 114 create a total internal reflection condition such that all of the optical signal is reflected at the second surface 114 towards the upper surface 118 of the epoxy 106. In some embodiments, a coating 502 is disposed on the surface 114 that allows for transmission of a portion of the optical signal. Thus, a portion of the optical signal is transmitted through the second surface 114, while another portion of the optical signal is reflected at the second surface 114 towards the upper surface 118 of the epoxy 106.

In summary, an optical coupler that provides vertical optical coupling includes an interlayer dielectric 104 that defines a cavity 116. The cavity 116 is filled with an epoxy 106, which may be index matched with the interlayer dielectric 104 or may have a higher index of refraction than the interlayer dielectric 104. The epoxy 106 directs an optical signal traveling laterally in the cavity 116 towards a surface 114 of the cavity 116 that redirects the optical signal upwards into a fiber or another optical device. In this manner, the optical coupler provides for vertical optical coupling with a wide spectral bandwidth, in certain embodiments.

The optical coupler may provide free-space out-of-plane deflection of horizontal waveguide light into a vertical fiber or component. As a result, the light is not edge coupled into the fiber or component, which eliminates some of the drawbacks of surface warpage. Moreover, the optical coupler may provide the optical coupling without using a grating coupler, which may increase the spectral bandwidth of the optical coupler relative to systems that use grating couplers.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. An optical coupler comprising:
an interlayer dielectric comprising a first surface and a second surface coupled to the first surface, wherein the first surface and the second surface define a first cavity in the interlayer dielectric;
a waveguide disposed within the interlayer dielectric, wherein the waveguide is arranged to emit an optical signal through the first surface; and
an epoxy disposed on the interlayer dielectric and in the first cavity such that the epoxy defines an upper surface and a bottom surface, wherein the bottom surface is positioned between the interlayer dielectric and the upper surface, wherein the epoxy is arranged to direct the optical signal from the first surface to the second surface, and wherein the second surface and the epoxy are arranged to direct a first portion of the optical signal through the upper surface.

2. The optical coupler of claim 1, wherein the first surface and the second surface are positioned at different angles relative to the bottom surface.

3. The optical coupler of claim 1, wherein the second surface is curved.

4. The optical coupler of claim 1, wherein the second surface and the epoxy direct the optical signal through the upper surface.

5. The optical coupler of claim 1, further comprising a coating disposed on the second surface, wherein the coating is arranged to direct the first portion of the optical signal through the upper surface.

6. The optical coupler of claim 5, wherein:
the interlayer dielectric further defines a third surface and a fourth surface coupled to the third surface;
the third surface and the fourth surface define a second cavity in the interlayer dielectric;
the coating and the second surface are arranged to direct a second portion of the optical signal through the third surface;
the epoxy is further arranged to direct the second portion of the optical signal to the fourth surface; and
the fourth surface and the epoxy are arranged to direct the second portion of the optical signal through the upper surface.

7. The optical coupler of claim 5, wherein the coating comprises a metal coating.

8. The optical coupler of claim 5, wherein the coating comprises a dielectric coating.

9. The optical coupler of claim 1, wherein the waveguide comprises a spot size converter.

10. The optical coupler of claim 1, wherein a refractive index of the epoxy is higher than a refractive index of the interlayer dielectric.

11. A method comprising:
emitting, by a waveguide disposed within an interlayer dielectric comprising a first surface and a second surface coupled to the first surface, an optical signal through the first surface, wherein the first surface and the second surface define a first cavity in the interlayer dielectric;
directing, by an epoxy disposed on the interlayer dielectric and in the first cavity such that the epoxy defines an upper surface and a bottom surface, the optical signal from the first surface to the second surface, wherein the bottom surface is positioned between the interlayer dielectric and the upper surface; and
directing, by the second surface and the epoxy, a first portion of the optical signal through the upper surface.

12. The method of claim 11, wherein the first surface and the second surface are positioned at different angles relative to the bottom surface.

13. The method of claim 11, wherein the second surface is curved.

14. The method of claim 11, wherein the second surface and the epoxy direct the optical signal through the upper surface.

15. The method of claim 11, further comprising directing, by a coating disposed on the second surface, the first portion of the optical signal through the upper surface.

16. The method of claim 15, wherein:
the interlayer dielectric further comprises a third surface and a fourth surface coupled to the third surface;
the third surface and the fourth surface define a second cavity in the interlayer dielectric; and
the method further comprising:
directing, by the coating and the second surface, a second portion of the optical signal through the third surface;
directing, by the epoxy, the second portion of the optical signal to the fourth surface; and
directing, by the fourth surface and the epoxy, the second portion of the optical signal through the upper surface.

17. The method of claim 15, wherein the coating comprises a metal coating.

18. The method of claim 15, wherein the coating comprises a dielectric coating.

19. The method of claim 11, wherein a refractive index of the epoxy is higher than a refractive index of the interlayer dielectric.

20. An optical coupler comprising:
an interlayer dielectric comprising a first surface and a second surface that define a cavity in the interlayer dielectric; and
an epoxy disposed on the interlayer dielectric and in the cavity, wherein the epoxy comprises an upper surface and a bottom surface positioned between the interlayer dielectric and the upper surface, wherein:
the epoxy is arranged to direct an optical signal from the first surface to the second surface; and
the second surface and the epoxy are arranged to direct the optical signal through the upper surface.
